(19) United States
(12) Patent Application Publication
(10) Pub. No.: US 2008/0105449 A1
(43) Pub. Date: May 8, 2008

(54) Periodic Variation of Velocity of Propagation to Reduce Additive Distortion Along Cable Length

(75) Inventors: Robert D. Kenny, Cincinnati, OH (US); Charles Wilker, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 11/935,466

(22) Filed: Nov. 6, 2007

Related U.S. Application Data
(60) Provisional application No. 60/857,051, filed on Nov. 6, 2006.

(51) Int. Cl. H01B 11/06; G02B 6/44; H01B 7/00; H01B 11/02

(52) U.S. Cl. 174/34; 174/113 R; 385/100

(57) ABSTRACT

A communications cable is provided that reduces the additive distortion of intended information encoded as electromagnetic energy that propagates longitudinally along the cable by varying the propagation velocity along its length. The additive distortion is reduced by varying the propagation periodically at a frequency that is lower than the highest frequency at which said electromagnetic energy propagates along said cable.

### FIELD OF THE INVENTION

The present invention relates to a communication cable transmitting electromagnetic energy encoded with information. More particularly, the present invention relates to a communication cable that reduces additive lo distortion of intended information encoded as electromagnetic energy during propagation of the electromagnetic energy along the cable by periodically varying the propagation velocity (Vp).

### BACKGROUND OF THE INVENTION

Category 6 (Cat 6) ethernet cable, traditionally operated up to 1 Gbit/s, does not meet the more stringent electrical specifications for Augmented Cat 6 cable, to be operated up to 10 Gbit/s at distances up to 100 meters. The primary limitation is in meeting the cable to cable noise immunity specification (alien crosstalk), particularly at frequencies from 100 to 500 MHz. As an example, for twist pairs, alien crosstalk is frequency dependent and usually exists between matched twist pairs within neighboring cables. A number of techniques have been suggested to reduce the electromagnetic interaction of these matched twist pairs by reducing either the capacitive (electric field) coupling, or the inductive (magnetic field) coupling.

Unshielded twist pair cable (UTP) has captured the largest share of the LAN (local area network) market primarily as a result of its low cost position versus other technologies, e.g. fiber optical cables. UTP cable is composed of four pairs of twist pair wire and was used originally as telephone cable. As the frequency of operation has increased, the demands on the materials of construction and fabrication tolerances have likewise increased. An entire family of improved resins (polymers) has been created to meet the electrical properties and the flame/smoke attributes required of the cable. In addition, new cable designs and twist schemes have been introduced to further improve the electrical performance of the cable. Augmented Cat 6 cable is currently emerging as a commercial product and a variety of designs have been offered in order to meet the more stringent electrical requirements. Current LAN infrastructure design layouts are based on data cables being no more than 0.250″ in diameter and these designs exceed this diameter.

It is desirable to create a communication cable that reduces the additive distortion of electromagnetic energy during propagation of the electromagnetic energy along the cable.

It is also desirable to have a 0.250 inch diameter cable that is not restricted to distances less than or equal to 60 meters for speeds greater than 1 Gbit/s.

### SUMMARY OF THE INVENTION

Briefly stated, and in accordance with one aspect of the present invention, there is provided a communications cable comprising intended information encoded as electromagnetic energy that propagates longitudinally along said cable with a propagation velocity, said cable guiding said electromagnetic energy reducing the additive distortion of said electromagnetic energy during propagation by periodically varying said propagation velocity at a frequency that is lower than the highest frequency at which said electromagnetic energy propagates along said cable.

Pursuant to another aspect of the present invention, there is provided a communications cable, as described in the immediate preceding paragraph, wherein the cable comprises: a) a conductor, and b) a dielectric material surrounding said conductor, wherein said dielectric material varies said propagation velocity relative to air along its length said variation being at least about 1%, more preferably at least about 1.3%, and most preferably at least about 2% relative to the speed of light in a vacuum.

Pursuant to another aspect of the present invention, there is provided a communications cable comprising intended information encoded as electromagnetic energy that propagates longitudinally along said cable with a propagation velocity, wherein said cable comprises a twist wire pair, said twist pair comprising:

a) a first conductor having a first dielectric material surrounding said first conductor forming a first insulated conductor; and

b) a second conductor having a second dielectric material surrounding said second conductor forming an second insulated conductor; wherein the first insulated conductor and second insulated conductor are twisted about one another forming said twist pair, said twist pair reducing the additive distortion of said electromagnetic energy during propagation by periodically varying said propagation velocity at a frequency that is lower than the highest frequency at which said electromagnetic energy propagates along said twist pair.

### BRIEF DESCRIPTION OF THE DRAWINGS

The invention will be more fully understood from the following detailed description, taken in connection with the accompanying drawings, in which:

FIG. 1 shows a shielded twist pair cross-sectional view.

FIG. 2 shows an unshielded twist pair cross-sectional view.

FIG. 3A shows an unvarying dielectric constant of 1.8 and thus, a constant propagation velocity over its cable length of 100 m.

FIG. 3B shows an impedance of 100 Ohms with a periodic 1 Ohm defect over its entire cable length of 100 m.

FIG. 3C shows the return loss versus frequency of a cable with the properties shown in FIGS. 3A and 3B.

FIG. 4A shows a varying dielectric constant of 1.8+0.1 sine and so a varying propagation velocity over its cable length of 100 m.

FIG. 4B shows an impedance of 100 Ohms with a periodic 1 Ohm defect (same defect as in FIG. 3B) over its entire cable length of 100 m.

FIG. 4C shows the return loss versus frequency of a cable with the properties shown in FIGS. 4A and 4B.

FIG. 5 shows uniform electrical length spacing of a periodic defect with constant propagation velocity along its cable length.

FIG. 6 shows the present invention of non-uniform electrical length spacing of a periodic defect with varying propagation velocity along its cable length.

FIG. 7 shows FIGS. 5 and 6 overlayed on one another to show the effect of the invention.

FIG. 8 shows a graphical representation of return loss vs. frequency for a comparative example and an example of the present invention to show the benefit of the present invention for a cable with a periodic defect.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

### Definitions:

The following definitions are provided as reference in accordance with how the terms are used in the context of this specification and the accompanying claims.

Additive Distortion is the accumulation of unwanted electromagnetic energy at a certain frequency due to regularly spaced features in a communications cable. These regular, i.e. equally spaced, features in the cable may be intentional design characteristics or unintentional imperfections introduced in the manufacturing process. For example, a damaged, or out-of-round pulley or wheel can repeatedly knick or compress the insulation of cable passing over it, the defect occurring at a frequency (defects/meter) determined by its diameter. Electromagnetic energy in the cable is distorted by each defect, creating distortion, one type being unwanted return loss. The more frequent the defects and the longer the cable, the greater the distortion. This distortion will accumulate at the frequency of electromagnetic energy that coincides with the electrical length spacing of the defects, and to a lesser extent, at multiples and odd harmonics of that frequency. This accumulation is called additive distortion and as it grows it causes increasing deterioration in the quality of information encoded at the frequency.

Alien crosstalk is signal coupled from one or more disturbing channels (a channel is a single stream of information) into a disturbed channel when the channels are located in different physical cables.

Cat 5/5e, also known as Category 5/5e cable, is an UTP cable type designed to reliably carry data up to 100 Mbit/s, e.g. 100BASE-T. Cat 5/5e includes four twist pairs of insulated 24 gauge copper wire in a single cable jacket each with three twists per inch. The twisting of the cable reduces electrical interference and crosstalk. Another important characteristic is that the wires are insulated with a plastic (e.g. FEP, a copolymer of tetrafluoroethylene and hexafluoropropylene) that has low dispersion, that is, the dielectric constant does not vary greatly with frequency. Special attention also has to be paid to minimizing impedance mismatches at the connection lo points. Cat 5e cable, which superseded Cat 5, is an enhanced version of Cat 5 that adds specifications for far-end crosstalk.

Cat 6, also known as Category 6 cable, is an UTP cable type designed to reliably carry data up to 1 Gbit/s. It is noted that Cat 6 is backward compatible with the Cat 5/5e and Cat 3 (Category 3 being the first unshielded twist pair cable suitable for 100 meter transmission of ethernet signals)standards but with more stringent specifications for crosstalk and system noise. Cat 6 includes four twist pairs of insulated 23 gauge copper wire in a single cable jacket each with different twist rates per inch. The cable standard is suitable for 10BASE-T/100BASE-T and 1000BASE-T. (10BASE-T is a UTP cable that is designed to reliably carry data up to 10 Mbit/s, 100BASE-T is a UTP cable that is designed to reliably carry data up to 100 Mbit/s, and 1000BASE-T is a UTP cable that is designed to reliably carry data up to 1000 Mbit/s.) Cat 7, also known as Category 7 cable, is a shielded twist pair cable designed to reliably carry data up to 10 Gbit/s. Note that Cat 7 is backward compatible with Cat 6, Cat 5/5e and Cat 3 of insulated 23 gauge copper wire) standards with even more stringent specifications for crosstalk and system noise. Cat 7 includes four twist pairs, just like the earlier standards except that shielding has been added for the individual twist pairs and/or for the cable as a whole.

Crosstalk is the unwanted transfer of energy from one signal path coupled to an adjacent or nearby signal path. An example of cross-talk would be the faint voices sometimes experienced during a phone conversation. Crosstalk can be capacitive (electric field) or inductive (magnetic field) and normally creates unwanted or erroneous data within a computer link or data system.

Dielectric constant, εᵣ, is a physical quantity that describes how a material affects an electric field and is related to the ability of the material to polarize and partially cancel the field. More specifically, it is the ratio of the amount of electrical energy stored in the material compared to that stored in a vacuum, for which εᵣ=1. The εᵣ of the wire insulation effects both the cable impedance and propagation velocity.

Differential signaling is a method of transmitting information over a lo pair of wires, which reduces noise by rejecting common-mode interference. Two wires are routed in parallel, and sometimes twisted together, so that they will receive the same interference. One wire carries the signal, and the other wire carries the inverse of the signal, so that the sum of the voltages on the two wires is always constant. At the end of the connection, instead of reading a single signal, the receiving device reads the difference between the two signals. Since the receiver ignores the absolute value of the voltages relative to ground, small changes in the ground potential do not affect the received signal. Also, the system is immune to most types of electrical interference, since any disturbance that lowers the voltage level on one wire will also lower it on the other. Some communications protocols that use differential signaling include SCSI, EIA232, Universal Serial Bus (USB) and FireWire.

Electrical Length, in a transmission medium, is physical length divided by the velocity of propagation of electromagnetic energy in the medium, expressed as a percentage of the velocity of propagation of electromagnetic energy in free space.

Ethernet is a computer networking technology for local area networks (LANs) mostly standardized as IEEE 802.3. It defines the wiring and signaling for the physical layer, and the protocols for the media access control/data link layer. The physical layer is the most basic network layer, providing the means of transmitting raw data bits. It contains, for example, specifications for the physical cabling, for collision control, for frequency allocation, and other low-level functions. Ethernet became the dominant LAN technology during the 1990s.

Impedance, Z, is a measure of opposition to a sinusoidal electric current and generalizes Ohm's law to AC circuits. The impedance of a circuit element is defined as the ratio of the instantaneous AC voltage to the instantaneous AC current, analogous to the DC resistance. Unlike electrical resistance, the impedance of an electric circuit can be a complex number. The characteristic impedance, Z_{C}, of a transmission line is set by its inductance, L, and its capacitance, C, per unit length.

$${Z}_{c} = \sqrt{\frac{L}{C}}$$

Intended Information is a signal that an operator or device desires to send from one point to another point.

Insertion loss is the amplitude of the transmitted signal measured at the cable output to that measured at the cable input, expressed in dB. A lower insertion loss means a larger signal is available at the cable output. The energy of the signal lost during its propagation down the cable is either dissipated as heat or reflected becoming return loss. Energy dissipation is due to resistive loss of the conductor and/or to dielectric loss of the polymeric insulation and/or spacers. The conductor loss depends upon the cross sectional area or gauge of the wire. The dielectric loss depends upon the insulation polymer's tan δ or loss angle. The insertion loss of a well designed cable is not significantly affected by any return loss.

Matched twist pairs are twist pairs that have a frequency matched to (or matched to a multiple of) the electrical length of the twist.

Non-uniform twist pair is one in which the twist rate of a twist pair varies along its length.

Propagation delay is the time for a signal to propagate from one end of the cable to the other, expressed in ns. A shorter propagation delay means the signal arrives at the output of the cable sooner. The delay time is a function of the signal velocity and the total length of the cable, for which the twist rate must be taken into account. The signal velocity depends upon and insulation dielectric and thickness. The cable length depends upon the physical cable length and twist.

Return loss is the amplitude of the reflected signal to that of the transmitted signal both measured at the cable input, expressed in dB. By convention, a higher return loss means less of the transmitted signal is reflected and so more is available at the cable output. Energy is reflected either from an impedance mismatch of the transmitter and cable, and/or from an impedance mismatch of the cable and receiver, and/or if the impedance of the cable is not uniform. Usually, the transmitter and receiver are designed to be 100Ω and so each twist pair within the cable should also be 100Ω. The impedance of each twist pair depends upon the wire gauge, twist, εᵣ, insulation thickness and to a lesser extent the configuration and materials of the remainder of the cable. Any variation from the fabrication process is a lo variation of the impedance. Abrupt, large variations yield more reflected energy.

Shielded twist pair (STP) cabling is primarily used for computer networking. Reference is made to FIG. 1 which shows a cross-sectional view of shielded twist pairs. Each twist pair 10 is formed by two insulated conductors 20 twisted or wound around each other and covered with a conducting overwrap to protect the wire from interference and to serve as a ground. This extra protection limits the wire's flexibility and makes STP more expensive than other cable types. Each conductor 20 is surrounded by insulation 30. A conductive shield 40 may surround a twist pair 10. Multiple twist pairs are encased in a sheath 50. Sheath 50 may include a conductive shield. These shields include foil wrapper or wire braid.

Uniform twist pair is one in which the twist rate of a twist pair is constant along its length.

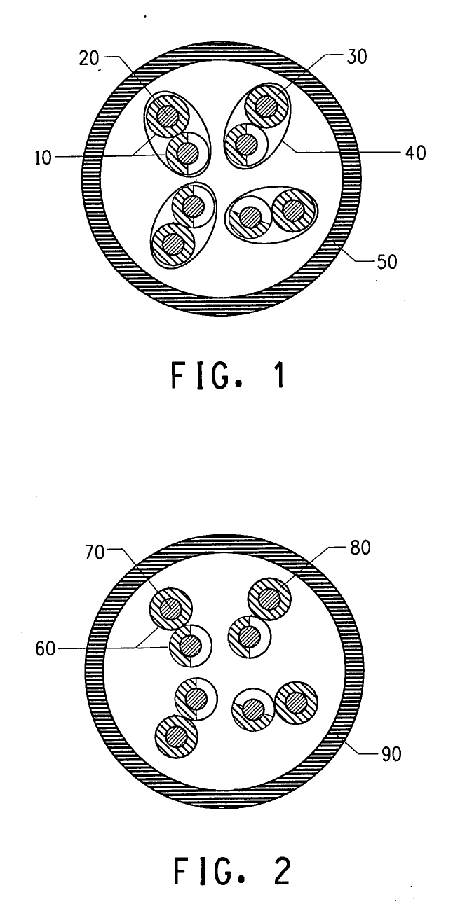

Unshielded twist pair (UTP) cabling is the primary wire type for telephone usage and is also common for computer networking. Reference is made to FIG. 2 which shows a cross-sectional view of unshielded twist pairs. Each twist pair 60 is formed by two insulated conductors 70 wound or twisted around each other for the purposes of canceling out electromagnetic interference which can cause crosstalk. Twisting wires decreases interference because: the area between the wires (which determines the magnetic coupling into the signal) is reduced; and because the directions of current generated by a uniform coupled magnetic field is reversed for every twist, canceling each other out. The greater the number of twists per meter, the more crosstalk is reduced. The conductors 70 are each surrounded by insulation 80. Multiple twist pairs are encased in a sheath 90.

Reference is now made to the detailed description of the present invention including but not limited to the embodiments disclosed herein. The purpose of a communications cable is to carry intended information from one physical location to another. The intended information is first encoded into electromagnetic energy, which is injected into one end of the cable. The electromagnetic energy then propagates along the length of the cable. Finally, the energy is decoded back into the information. It is important that lo during propagation longitudinally along the cable, the electromagnetic energy is not markedly distorted which might degrade or destroy the information.

Electromagnetic energy can be guided in space by either a good conductor or by a good dielectric or by a combination of the two. The velocity of propagation of the electromagnetic energy depends upon the transverse physical configuration of the conductor, or the transverse physical configuration as well as the material properties of the dielectric or by a combination of conductors and dielectrics. Any longitudinal deviation of the transverse physical configuration or of the dielectric material properties leads to some distortion of the electromagnetic energy.

Longitudinal deviations may occur periodically, i.e. at regular intervals, often arising in the manufacturing and handling processes, in which the cable is subject to the influence of rotating machinery, such as extruders, pulleys, and windup equipment. When these deviations occur, the distortion is additive at some frequency of the electromagnetic energy. If the magnitude of the additive distortion becomes large enough then some of the information may be lost. It is noted that at any frequency within the operating bandwidth, the effect of a distortion on the information depends upon the information encoding details. It is noted that the higher the electromagnetic energy frequency, the additive distortions tend to be greater when they occur.

The interval between two longitudinal deviations is a combination of the physical separation between the deviations and of the propagation velocity. If the physical separation is changed to another value, then the additive distortion just shifts to another frequency. If the propagation velocity is changed to another value, then the additive distortion again just shifts to another frequency.

In the present invention a periodic variation is applied to the communications cable. This periodic variation comprises a slow (i.e. low frequency), periodic variation of either the physical separation of the conductors, the propagation velocity, or both, will reduce the peak value of an additive distortion at a particular frequency. A slow variation means that any change between two adjacent longitudinal deviations is small when compared to the total of the slow, periodic variation. A periodic variation means that the lo period of the slow, periodic variation occurs relative to the total cable length. The effect of a slow, periodic variation of either the physical separation or the propagation velocity is to “spread out” the distortion among a number of frequencies, thus reducing the effect at any one particular frequency. This reduces the degradation of the intended information being propagated. The slow, periodic variation may comprise a sinusoidal, triangular, square, quadratic, or similar type of wave or combinations thereof.

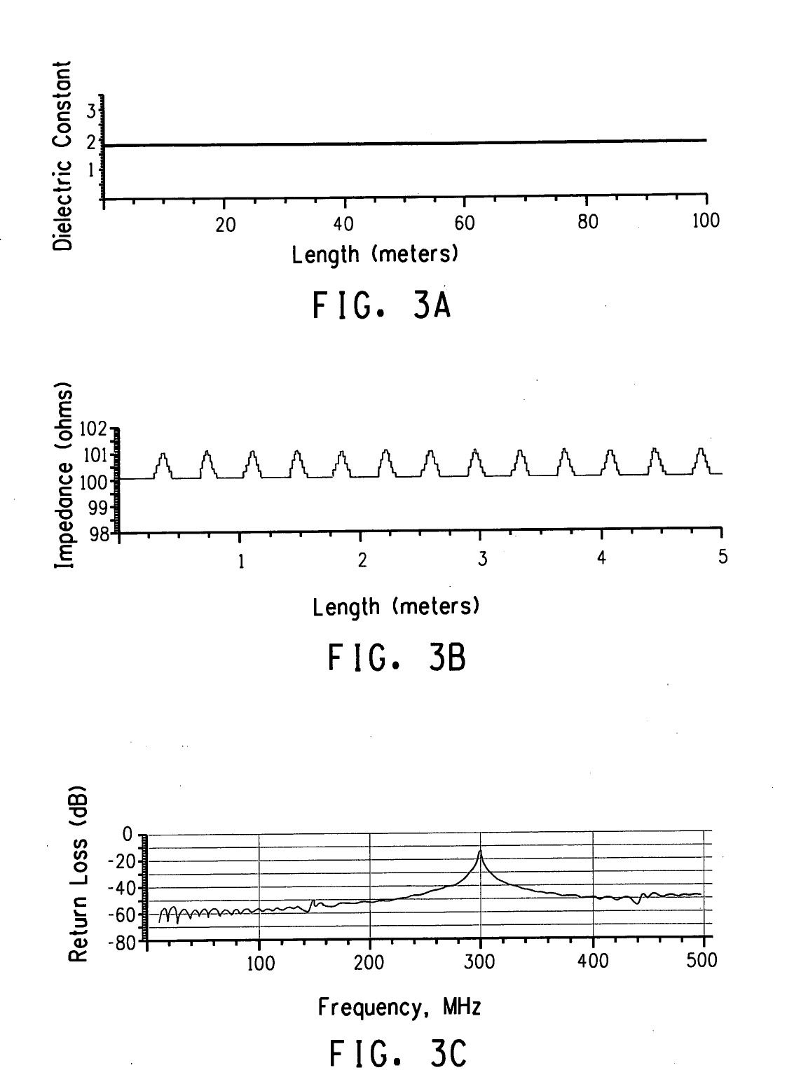

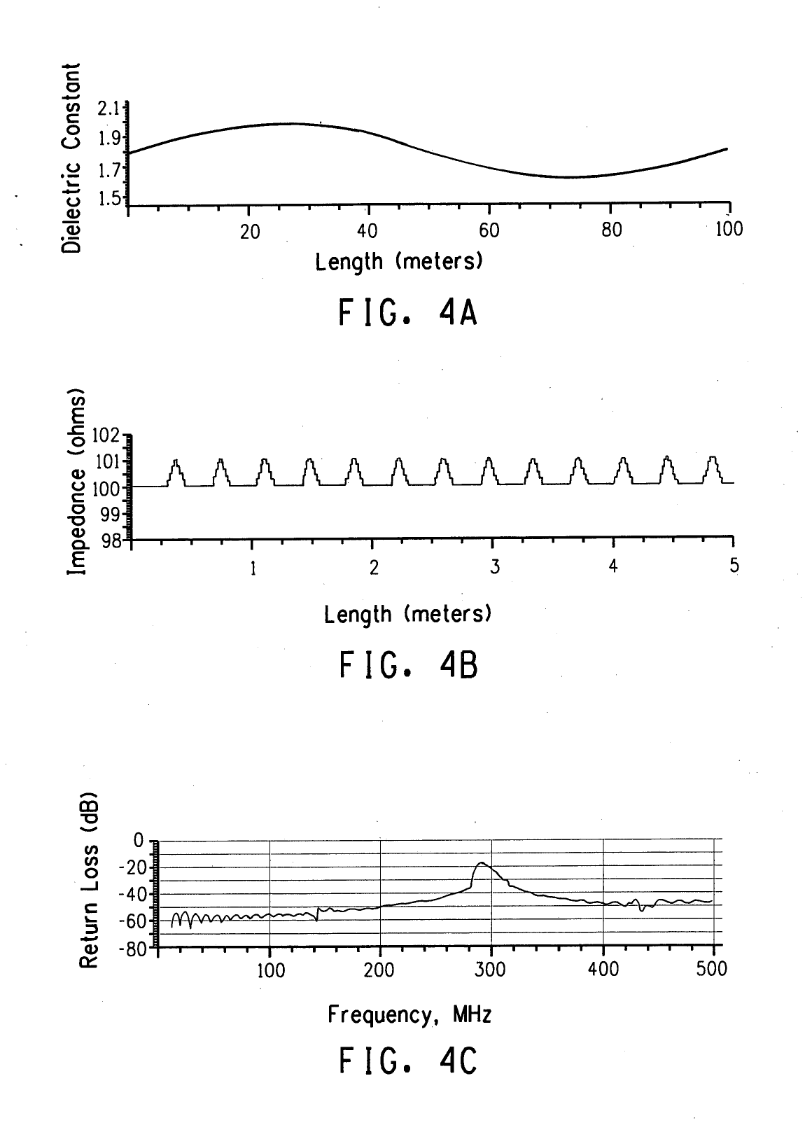

Reference is now made to FIGS. 3A, 3B and 3C. A cable with an unvarying dielectric constant (εᵣ=1.8) over its cable length of 100 m is shown in FIG. 3A. The cable impedance of 100 ohms is shown in FIG. 3B with a defect of magnitude 1 ohm at regular intervals along the cable length, the result of faults introduced in manufacture. The return loss (dB) is shown in FIG. 3C. Note the maximum of return loss concentrating at 300 GHz. In contrast, the same cable, with a slow periodic sinusoidal variation of the dielectric constant, is shown in FIG. 4A. With a similar impedance as in FIG. 3B (see FIG. 4B), the return loss (FIG. 4C) (dB) curve is flattened and broadened showing reduced additive distortion at 300 MHz by distributing the distortion over a range of wave lengths, this being accomplished by varying the propagation velocity, the effect of the slow periodic sinusoidal variation of the dielectric constant.

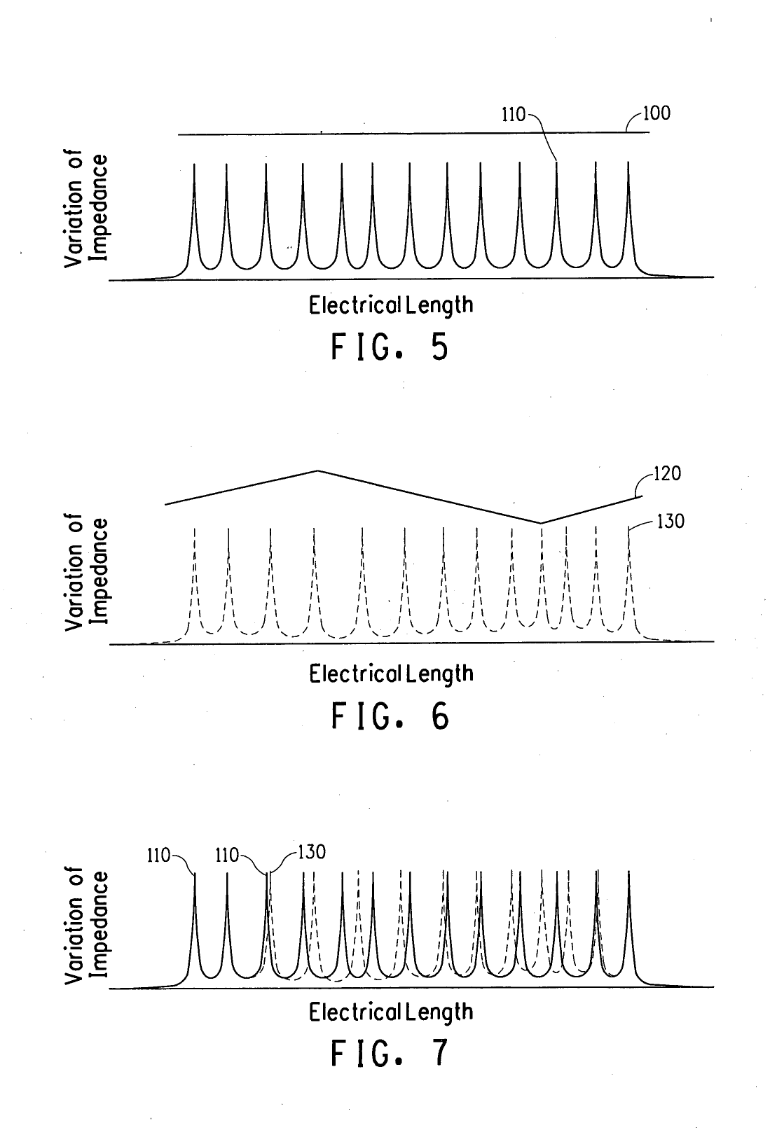

Reference is now made to FIG. 5 which shows a small section of the cable length. The straight line 100 indicates the uniformity (e.g. lack of variability) of the dielectric constant along the electrical length. When the dielectric constant does not vary, then the propagation velocity also does not vary. Hence, the electrical length between successive impedance “bumps” 110 as shown in FIG. 5 does not vary and the return loss distortion is fully additive.

Reference is now made to FIG. 6 which shows a small section of cable length. The bent line 120 indicates the variability of the dielectric constant along the electrical length. When the dielectric constant varies as a triangle, the propagation velocity increases, then decreases, and then increases as shown in FIG. 6. Hence, the electric length between successive impedance “bumps” 130 varies and the return loss distortion is “spread” out as in the present invention.

FIG. 7 shows the electrical length between successive impedance bumps 110 that do not vary, overlaid over the successive impedance bumps 130 that do vary along the electrical length (FIG. 6). FIG. 7 shows that the electrical length variance between successive impedance bumps 130 is offset from that of the non-varying successive impedance bumps 110. The electrical length variance between the successive bumps 130 spreads out the return loss distortion allowing the twisted wires to be more closely aligned.

The communications cable of the present invention can be an insulated conductor, a twist pair, a coaxial cable, an optical fiber or any other like means of transferring information. In the present invention, an insulated conductor includes conductors such as metal, specifically metal wire. An insulative material such as glass or plastic surrounds the metal conductor. The insulative material, in an embodiment of the present invention is a dielectric material. In the present invention, changes to the dielectric material vary the propagation velocity of the intended information relative to air along the length of the cable about at least 1%, more preferably at least about 1.3% and most preferably at least about 2% relative to the speed of light in a vacuum. Preferably the dielectric material varies propagation velocity along a length of cable about 10 meters to 2000, more preferably 60 meters to 1000 meters and most preferably about 60 to 300 meters at a minimum of 1% relative to the speed of light in a vacuum. For example, if the average propagation velocity in a cable is 70% of the velocity of light in a vacuum, a 2% variation relative to the speed of light means that the propagation velocity in the cable ranges between 68% and 72% of the speed of light in a vacuum.

The dielectric material varies propagation velocity preferably about 1%-10% or more preferably about 1.3%-10% or most preferably about 2%-10% relative to the speed of light in a vacuum over the cable length, where the cable length is preferably about 100 meters to 1000 meters.

The dielectric material of the present invention comprises thermoset or thermoplastic material. The dielectric material may also be a foamed polymer. The dielectric material is preferably a thermoplastic material such as polyolefin, fluoropolymer, polyvinyl chloride (PVC) or combinations thereof. Preferred polyolefins include polyethylene (PE), polypropylene (PP) and combinations thereof. It is noted that PP and PE, for purposes of this invention, also include flame retardant PP and PE. Preferred fluoropolymers include polytetrafluoroethylene (PTFE), the copolymer of tetrafluoroethylene (TFE) and hexafluoropropylene (HFP), known as FEP, which may also contain some PAVE (see below), the copolymer of ethylene (E), TFE, and HFP, known as EFEP, and the copolymer of TFE and perfluoro(alkyl vinyl ether) (PAVE), known as PFA. Preferred PAVE are perfluoro(propyl vinyl ether) (PPVE), perfluoro(ethyl vinyl ether) (PEVE), and perfluoro(methyl vinyl ether) (PMVE), which polymer may also contain PPVE, and is sometimes called by its manufacturer, MFA. Also preferred are: the copolymer of E and TFE, known as ethylene/tetrafluoroethylene (ETFE); the copolymer of E and chlorotrifluoroethylene (CTFE), known as ECTFE; the homopolymer of vinylidene fluoride (VF2), known polyvinylidene fluoride (PVDF), and copolymers of VF2, such as TFENF2, and TFE/HFPNF2, known as THV. The more preferred copolymer is FEP.

The dielectric of the insulation may be varied periodically according to the present invention in a number of ways. For example, the degree or the type of foaming of the insulation may be varied periodically in the manufacturing process (wire extrusion) by varying the gas pressure if foaming is done with gas injection, or by varying the amount or type of nucleating agent. Alternatively, dielectric may be varied by altering the composition of the dielectric, for example by varying the comonomer (HFP) composition of FEP periodically as wire is extrusion coated. A third approach is to treat the insulated wire after extrusion, such as by exposing foamed insulation to periodically varying thermal or mechanical conditions to shrink or compress the foam, thereby changing its dielectric.

In another embodiment of the present invention the communications cable may be optical fiber. The preferred optical fiber material comprises glass such as amorphous silica, or amorphous plastic such as acrylic or the amorphous fluoropolymer, Teflon AF®.

In yet another embodiment of the present invention, one or more twist pairs may be used as the communications cable. The twist pair(s) may be shielded or unshielded. A twist wire pair comprises two of the single lo insulated conductors, described above, twisted about one another to form a twist pair. The twist wire pair, of the present invention, reduces additive distortion of the intended information during propagation by periodically varying the propagation velocity (Vp) at a frequency that is lower than the highest frequency at which the encoded electromagnetic energy propagates along the length of the twist pair. The propagation velocity along the twisted wire pair length varies by at least about 1%, more preferably at least about 1.3%, and most preferably at least about 2% relative to the speed of light in a vacuum over a preferable distance of at least 10 meters and more preferably at least 20 meters and most preferably at 60 meters. It is noted that the Vp of about 1%-10% or more preferably 2%-10% relative to the speed of light in a vacuum over the cable length mentioned above is also applicable to twist pair cable and other communications cable such as those previously mentioned.

In twist pairs, inductive effects generally have greater influence than dielectric effects. That is, the proximity of the conductors in the pair to one another varies because of twist effects and mechanical influences, changing the inductive effects between the conductors. The periodic variation according to this invention can be achieved by periodic changes in the diameter of the insulation, such as by compressing or shrinking foamed polymer insulation to vary the degree by which the two conductors approach one another in the twist pair. It should be noted that an insulated conductor of the present invention need be only one of the insulated conductors of the twisted pair. The other insulated conductor can be a conventional insulated conductor or may be the insulated conductor of the invention. To achieve the benefits of the present invention, it is only necessary that one of the insulated conductors of the twist pair have a periodic variation in the velocity of propagation.

The propagation delay of a twist pair can be determined in a variety of ways. In one such method for the present invention, the propagation delay of the twist pair is greater than about 20 nanoseconds per 10 meters when measured in accordance with ANSI/SCTE 49-2002. (E.g. A single length of about 1000 meters of the twist pair length is cut into several cable sections of separate lengths of about 10 meters each, to measure propagation delay, the difference between the 10 m piece with the lowest propagation delay and the piece with the highest propagation delay of a 10 meter twist pair unit is more than about 20 nanoseconds per 10 meter length.) In an embodiment of the present invention, each of the insulated conductors of the twist pair varies in propagation velocity at a similar rate to one another along the twist pair length. In a further embodiment of the present invention, each of the insulated conductors vary in propagation velocity within 1% of each insulated conductor at any point when tested at a same location along the length of said twist pair.

A twist wire pair of the present invention may be twisted uniformly or non-uniformly. For a uniform twist wire pair, the propagation velocity along the twist wire pair length varies by at least 1%, more preferably at least about 1.3%, and most preferably at least about 2% relative to the speed of light in a vacuum over the twist pair length of at least 10 meters and more preferably 20 meters and most preferably 60 meters. Another method of measuring the propagation velocity of the twisted pair is as follows. The uniformly twisted twist wire pair has a propagation velocity that varies over a twist pair length of at least 10 meters when compared to at least two other 10 meter sections along a continuous 1000 meter twist pair length that is devoid of material defects, breaks, or voids.

For a non-uniform twist wire pair of the present invention, the twist pair is untwisted and the Vp relative to the speed of light in a vacuum is measured over a single insulated conductor of the twist pair for a length of at least 10 meters and more preferably 20 meters is at least about 1%. In an embodiment of the present invention, the first twist pair is in close proximity to at least a second twisted pair that does not vary in propagation velocity along the length of the second twist pair.

In another embodiment of the present invention, at least a second twist pair is in close proximity to the first twist pair where the second twist pair varies in dielectric either independently or dependently of the first twist pair.

In another embodiment of the present invention, a first twist pair is in close proximity to a dielectric substance, and the dielectric substance comprises a filler material that separates the first twist pair from the at least one or more second twist pair within a group of pairs.

In another embodiment of the present invention, twist pair is in close proximity to a dielectric substance, where the dielectric substance comprises a jacket encasing a twist pair.

In another embodiment of the present invention, the twist pair is in close proximity to a dielectric that is a coating against a shield or metallic substance such as polyolefin, polypropylene, or polyethylene. Another embodiment of the present invention is where the twist pair is in close proximity to a metallic shield such as copper or aluminum.

In the present invention the twist pair passes National Fire Prevention Association tests 255, 259 or 262.

In the present invention, the single insulated conductor, the twisted pair and other communication cable embodiments, periodically vary propagation velocity at a frequency with a preferable bandwidth no greater than 1000 MHz and, more preferably with a bandwidth no greater than 625 MHz.

An example of a twist pair cable is a Cat 6 cable. A Cat 6 cable has a wide range of electrical specifications and thus, requires meticulous design and fabrication within tight tolerances to meet such a broad range of electrical specifications. Introducing a controlled variation of a dielectric constant along the length of the wire, as in the present invention, provides a significant effect on the return loss, crosstalk and alien crosstalk. Any regularly spaced defect can potentially yield a cable with out-of-spec return loss and/or crosstalk. Cable fabrication equipment, based on rotating machinery for example, creates regularly spaced variations in the twist pairs. A physical defect in the geometry of a twist pair corresponds to an impedance variation. Any change of the impedance causes some of the transmitted energy to be reflected back toward the cable input. If the impedance discontinuities are evenly spaced and have a uniform propagation velocity then they all have the same electrical length. At the frequency corresponding to this electrical length, all of the reflections add constructively creating a large reflected signal or out-of-spec return loss (e.g. distortion or defect). A back-twist is an example of the attempt to physically disturb the regular spacing of the defects and thereby improve cable performance. Alternatively, the electrical length can be varied along the length of a twist pair to disturb the regular spacing of the defects thereby improving the return loss of a cable. However, it is noted that a linear lo variation of the electrical length along the length of a twist pair would only shift the frequency of the return loss but not change its magnitude. A non-linear variation, e.g. sinusoidal, triangular or square, with a period of between 1 and 1000 m would improve the return loss of a cable and potentially relax the fabrication tolerance.

Many conditions must be met in order for a pair of twist pairs to exhibit strong coupling (i.e. to have an out-of-spec crosstalk) such as those indicated in the following bullet points:
The twist pairs must be in close proximity.
The twist pairs must be parallel over a long distance.
The twist pairs must have a matched (or be matched to a multiple of the) electrical length of their twists.
The twist pairs must have their twists aligned.
The twist pairs must carry a signal having a frequency matched to (or matched to a multiple of) the electrical length of the twist.

### (It is noted that that the sources of coupling are the same between twist pairs located within the same cable or within neighboring cables.)

Within the same cable, the fabrication tolerance may create an overlap between the twist lay of supposedly different twist pairs. A controlled variation of the electrical length along the length of both twist pairs, disturbs the match of the electric length between the twist lays. This would improve (i.e. reduce) the crosstalk and relax the fabrication tolerance.

Alien crosstalk is dominated by matching twist pairs in neighboring cables. A controlled variation of the electrical length along the length of both twist pairs, disturbs the match of the electric length between the twist lays. This would improve the alien crosstalk and allow for a reduction of the overall cable size for the reasons stated with reference to FIGS. 5-7 mentioned above.

An embodiment of the present invention is an independent slow periodic variation of the electrical length for each twist pair of unshielded twist pair (UTP) cable to improve its manufacturability. Periodic structures and defects in the as fabricated cable introduce peaks in the frequency response of the crosstalk and return loss performance of a cable. A slow periodic lo variation of the electrical length does not change the area underneath these frequency response peaks but it does broaden the peak thereby “chopping-off” the top of the peak yielding an improvement of for example a 3 to 6 dB improvement. This beneficial effect is additive to any other effects introduced during fabrication, e.g. back twist.

In the present invention, two such applicable fabrication techniques include: 1) Introducing a slow variation of the total diameter of the insulated conductor during the fabrication of a single wire. This can be done by varying the preheat temperature of the copper wire using rf induction. It would be important to align the variation between the two single wires used to create one twist pair. 2) Introducing a slow variation of the spacing between the copper wires of a twist pair. This can be done by varying the time a twist pair spends in a cold rf (radio frequency) plasma. It is important to hold the twist pair under longitudinal tension so that the copper wire spacing moves to accommodate the wire insulation shrinkage.

### EXAMPLE 1

The impedance of the cable is 100 Ω with a defect magnitude of an additional 1Ω. The total length of the cable is 100 m. The defects are spaced 0.3724 m apart (14.7 inches) which for a dielectric constant of 1.8 should yield a peak in the return loss at 300 MHz.

A twist (or back twist) applies non-uniform torque to a cable. The spacing of the defects is affected as a function of its location within the cable. The defects at the end of the cable are affected the most moving 1 cm while defects at the center are not affected at all. A linear distribution of the torque would only shift the return loss peak but not affect its height. A non-linear distribution of the torque “smears-out” the peak reducing its height. Table 1 shows modeling data of return loss improvement. In one case the applied periodic variation is triangular in shape. In another, it is sinusoidal in shape.

TABLE 1

| | | | Return | | Return Loss |
|---|---|---|---|---|---|
| | Dielectric | Twist | Loss | Impedance | Improvement |
| | Constant | (cm) | (dB) | (Ohms) | (dB) |
| standard | 1.8 | 0 | 11.9 | 77 to 117 | 0 |
| configuration | | | | | |
| with twist | 1.8 | −1 | 13.3 | 94 to 151 | 1.4 |
| with controlled | 1.8 ± 0.1 | 0 | 13.8 | 73 to 110 | 1.9 |
| electrical length | Triangle | | | | |
| variation | | | | | |
| with both | 1.8 ± 0.1 | −1 | 14.8 | 67 to 140 | 2.9 |
| | Triangle | | | | |
| with controlled | 1.8 ± 0.1 | 0 | 13.8 | 67 to 109 | 1.9 |
| electrical length | Sine | | | | |
| variation | | | | | |
| with both | 1.8 ± 0.1 | −1 | 15.3 | 86 to 134 | 3.4 |
| | Sine | | | | |

### COMPARATIVE EXAMPLE 1

This example demonstrates the effect of an additive distortion caused by a periodic defect in an insulated conductor. Copper conductor (24 ga., 20 mils, 500 μm)was coated with foamed FEP fluoropolymer insulation, 8 mils (200 μm) thick on a conventional wire coating line. A capstan wheel (18 in (45 cm) in diameter) in the line was modified to have a raised portion (bump) that affected the tension on the coated wire once per revolution causing the defect. The line was run at 700 ft/min (213 m/min). 10,000 meters of insulated conductor was made. Measurements taken during the coating operation using Sikora Centerview 2010 testing equipment showed that the insulated conductor had a velocity of propagation (Vp) of 75.45% (100% being the speed of light in a vacuum).

Lengths of the control wire were paired and twisted in Thermoplastics Engineering Corporation (TEC) wire twinning equipment, Model No. BTTW560E. The wire was twisted at a 0.5″ (12.3 mm) lay at 2200 twists/min with a 30% backtwist. The resulting twisted pair was cut into 100 meter lengths for testing.

Ten samples were tested on a DCM Industries SCS-350 Structural Cabling Component Compliance Test System using an 8753 HP Network Analyzer, making 801 measurements in the range of 1 to 350 MHz. A minimum of five tests were run on each sample, during which time, if lo necessary, the sample length was adjusted by cutting to maximize the additive distortion. These adjustments by cutting were on the order of 2-5 cm.

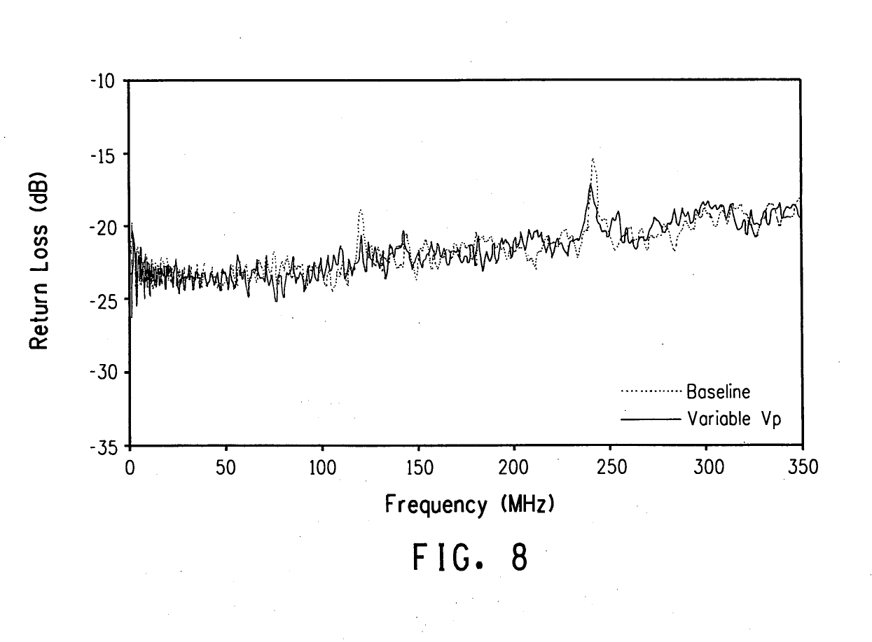

The additive distortion was seen as return loss at 240 MHz and to a lesser extent at 120 MHz. This is shown in FIG. 8 by the baseline graph. The average return loss at 240 MHz=12.6 db and the average return loss at 120 MHz=13.1 db.

### EXAMPLE 2

An example of the present invention is demonstrated by this example. The conditions of the Comparative Example are repeated for this example with the exception that the position of the water bath, used to cool the coated conductor after it exits the extruder, was varied during the coating run. A length of about 30 inches (75 cm)of the coated wire is immersed in the bath. The normal position for the bath is about 1 ft (30 cm) from the point at which the coated conductor exits the extruder coating die. The bath was moved from 6-18 inches (15-45 cm) from the exit point at a frequency of 12-14 sec per cycle. During the cycle approximately 150 ft (45 m) of insulated conductor passes through the bath. This was the wavelength of the variation and corresponds to a frequency of about 5 MHz. The effect was to change the rate of cooling of the coated conductor and thereby affect the rate and extent of shrinkage of the insulation. In this Example insulation diameter varied ±0.001 inch (25 μm). The shape of the variation along the length of the insulated conductor approximates a triangular wave. By measuring consecutive samples of insulated conductor, it was established that Vp varies from 74.8% to 76.1% (i.e.1.3%). The mean Vp is 75.45%. This is the same as that of the Comparative Example, though of course, the Vp did not vary in the Comparative Example.

Samples of the insulated conductor of this Example were twinned with insulated conductor of the Comparative Example to make twisted pairs for testing. Measurements were made on these twisted pairs similar to those done on the Comparative Example. The average return loss at 240 MHz=14.2 db and the average return loss at 120 MHz=14.8 db. See FIG. 8.

The improvement in return loss seen in the Example 2 (Variable Vp of FIG. 8) compared to the Comparative Example (Baseline of FIG. 8) was 1.6 dB at 240 MHz and 1.7 dB at 120 MHz. The variation in Vp, introduced by operations in the manufacturing process reduced the additive distortion caused by periodic defects in the insulated conductor.

Example 2 demonstrates that the introduction of a controlled periodic variation along the length of a communication cable can reduce the effect of the defects by mitigating return loss. Though cross talk is not measured in this Example, cross talk would be reduced also.

It is therefore apparent that there has been provided in accordance with the present invention, a communications cable that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

It is claimed:

1. A communications cable comprising intended information encoded as electromagnetic energy that propagates longitudinally along said cable with a propagation velocity, said cable guiding said electromagnetic energy reducing additive distortion of said electromagnetic energy during propagation by periodically varying said propagation velocity at a frequency that is lower than the highest frequency at which said electromagnetic energy propagates along said cable.

2. A communications cable according to claim 1, wherein periodically varying said propagation velocity comprises a sinusoidal, triangular, square, quadratic, similar wave or combinations thereof.

3. A communications cable according to claim 1, wherein said cable comprises a dielectric, conductor or a combination thereof.

4. A communications cable according to claim 1, wherein said cable comprises:
a) a conductor, and
b) a dielectric material surrounding said conductor, wherein said dielectric material varies said propagation velocity relative to air along a length of said cable and at least about 1% relative to the speed of light in a vacuum.

5. A communications cable according to claim 4, wherein said dielectric material varies propagation velocity over a length of about 10 meters to 1000 meters of cable.

6. A communications cable according to claim 1, wherein said cable comprises an insulated wire, a twist pair, a coaxial cable, or an optical fiber.

7. The communications cable according to claim 6, wherein said cable comprises a twist pair having insulated conductors, said insulated conductors each having a conductor surrounded by dielectric material, said dielectric material varies said propagation velocity relative to air along a length of said cable and at least about 1% relative to the speed of light in a vacuum.

8. A communications cable according to claim 6, wherein said twist pair is shielded or unshielded.

9. A communications cable according to claim 6, wherein said optical fiber comprises glass or plastic.

10. A communications cable according to claim 1, wherein said cable comprises a twisted wire pair, said twist pair comprising:
a) a first conductor having a first dielectric material surrounding said first conductor forming a first insulated conductor; and
b) a second conductor having a second dielectric material surrounding said second conductor forming an second insulated conductor; wherein the first insulated conductor and second insulated conductor are twisted about one another forming said twist pair, said twist pair reducing additive distortion of said electromagnetic energy during propagation by periodically varying said propagation velocity at a frequency that is lower than the highest frequency at which electromagnetic energy propagates along said twist pair.

11. A communications cable according to claim 10, wherein said twist pair varies propagation velocity along said twist pair length at least about 2% relative to the speed of light in a vacuum.

12. A communications cable according to claim 11, wherein said twist pair is twisted uniformly and said propagation velocity varies over a twisted pair length of at least 10 meters.

13. A communications cable according to claim 12, wherein said uniformly twisted twist pair varies said propagation velocity over a twisted pair length of at least 10 meters when compared to at least two other 10 meter sections along a continuous 1000 meter twist pair length that is devoid of material defects, breaks, or voids.

14. A communications cable according to claim 10, wherein at least one of said first insulated conductor and said second insulated conductor varies in propagation velocity at a similar rate to one another along said twist pair length.

15. A communications cable according to claim 10, wherein an overall dielectric constant of each of said first dielectric material and said second dielectric material is less than about 2.

16. A communications cable according to claim 10, further comprising at least a second twist pair, wherein said twist pair is in close proximity to said at least a second twist pair that does not vary in propagation velocity along the length of said at least second twist pair.

17. A communications cable according to claim 10, further comprising at least a second twist wire pair, wherein said twist pair is in close proximity to said at least a second twist pair that does vary in a dielectric either independently or dependently of said twist pair.

18. A communications cable according to claim 10, further comprising at least one or more second twist pair, wherein said twisted pair is in close proximity to a dielectric substance, said dielectric substance comprising a filler material separating said twisted pair from said at least one or more second twist pair within a group of pairs.

19. A communications cable according to claim 10, wherein said twist pair is in close proximity to a dielectric substance, said dielectric substance comprising a jacket encasing said twist pair.

20. A communications cable according to claim 10, wherein said twist pair is in close proximity to a dielectric substance, said dielectric substance being coated against a shield or metallic substance.

21. A communications cable according to claim 4, wherein said dielectric material is a foamed polymer.

22. A communications cable according to claim 13, wherein said dielectric material is a foamed polymer.
